(19) United States
(12) Patent Application Publication
(10) Pub. No.: US 2018/0346845 A1
(43) Pub. Date: Dec. 6, 2018

(54) LAUNDRY DETERGENT COMPOSITION

(71) Applicant: Conopco, Inc., d/b/a UNILEVER, Englewood Cliffs, NJ (US)

(72) Inventors: Stephen Norman BATCHELOR, Chester (GB); Jayne Michelle BIRD, Ellesmere Port (GB)

(73) Assignee: Conopco, Inc., d/b/a UNILEVER, Englewood Cliffs, NJ (US)

(21) Appl. No.: 15/761,662

(22) PCT Filed: Sep. 27, 2016
(86) PCT No.: PCT/EP2016/072929

§ 371 Date: Mar. 20, 2018

(30) Foreign Application Priority Data
Oct. 1, 2015 (EP) 15187966.5

(51) Int. Cl. C11D 3/20; C11D 1/831; C11D 3/386; C11D 11/00

(52) U.S. Cl. CPC C11D 3/2089; C11D 1/831; C11D 1/72; C11D 11/0017; C11D 3/386

(57) ABSTRACT

The present Invention provides a formulation for use in domestic laundry comprising anionic surfactant and or nonionic surfactant and stearyl ether carboxylic acid.

### FIELD OF INVENTION

The present invention provides a cleaning formulation containing alkyl ether carboxylate for use in domestic laundry.

### BACKGROUND OF INVENTION

WO2013/087286 (Unilever) discloses liquids formulations containing alkyl ether carboxylic acids, betaines, anionic surfactant, non-ionic surfactant for providing softening benefits.

U.S. Pat. No. 5,269,960 (Clorox) discloses liquid aqueous enzyme detergent containing enzymes, non-ionic surfactant, fatty acid and alkyl ether carboxylic acids that have enhanced physical and enzyme stability.

EP0154380 discloses a laundering agent which contains active detergent, builders, a combination of polyphosphate with zeolite as sequestering agent and, if desired, further usual additives, wherein the sequestering effect of the polyphosphate-zeolite combination is enhanced by an ethercarboxylic acid of the formula RO—(C2H4O)x-CH2COOM or R—CO—NH—(C2H4O)x-CH2COOM, wherein R is the residue of an aliphatic or alkyl aromatic hydrocarbon having at least 8 carbon atoms, x is a number having an average value of 0.5-20 and M is hydrogen or a cation permissible in laundering agents, said polyether carboxylic acid being present in an amount of 0.3 to 10 percent, preferably 0.3 to 5 percent, based on the entire composition.

U.S. Pat. No. 3,741,911 discloses a detergent composition, preferably phosphate-free, built using conventional builders, optionally including an organic sequestering agent, and contains as the active 15 system a coacervate system containing an alkyl or alkyl-aryl polyoxyalkylene carboxylic acid and a non-ionic detergent. The coacervate system is suitable for washing fabrics and for use in automatic dish washing machines.

There is a need to increase the cleaning performance of detergent formulations containing saturated alkyl ether carboxylates with high level of ethoxylation.

### SUMMARY OF THE INVENTION

A stearyl ether carboxylate with 10 to 20 ethoxylate units, provides enhanced cleaning in detergent formulation.

In one aspect the present invention provides detergent formulations comprising:
(i) from 10 to 40 wt % of a surfactant selected from: anionic and non-ionic surfactants, preferably from 12 to 25 wt %, more preferably 14 to 21 wt %, preferably wherein the weight fraction of non-ionic surfactant/anionic surfactant is from 0 to 0.3, preferably 0 to 0.15, most preferably 0 to 0.12 [the alkyl ether carboxylic acid dispersant of integer (ii) does not contribute to this ratio and also does not contribute to the amount defined in integer (i)];
(ii) from 0.5 to 10 wt %, preferably 1 to 5 wt %, an alkyl ether carboxylic acid dispersant, in addition to other surfactants present, the alkyl ether carboxylic acid dispersant of the following structure:

CH₃(CH₂)₁₇—(OCH₂CH₂)ₙ—OCH₂—COOH,
wherein:
   n is the average ethoxylation and n is selected from 10 to 20, preferably 15 to 20; and,
(iii) preferably from 0.002 to 0.2 wt % of a subtilisin protease enzyme, preferably from 0.005 to 0.05 wt %.

Subtilisin protease enzymes are members of the subtilase type serine proteases family.

With the exception of the alkyl ether carboxylates, the wt % of anionic surfactants are calculated as the sodium salt. The wt % of the alkyl ether carboxylates are calculated in the protonated form: CH₃(CH₂)₁₇—(OCH₂CH₂)ₙ—OCH₂—COOH. The wt % of protease enzyme is for the pure active enzyme.

In another aspect the present invention provides a domestic method of treating a textile, the method comprising the step of: treating a textile with an aqueous solution of 1.5 to 20 g/L of the laundry detergent composition as defined herein. A subsequent aqueous rinse step and drying the textile is preferred.

Preferably the aqueous laundry detergent solution to remain in contact with the textile for 10 minutes to 2 days then rinsing and drying the textile. Preferably the aqueous laundry detergent solution contain 0.05 to 0.5 g/L of the alkyl ether carboxylates of the present invention. This aids cleaning.

Preferably the water in the aqueous laundry detergent solution has a hardness from 6 to 40 degrees French hard. Preferably the water in the aqueous laundry detergent solution has a temperature from 280 to 315K. Fatty acid is preferably present in the aqueous laundry detergent solution. Preferably the fatty acid is selected from predominately saturated and mono-unsaturated linear fatty acid with C16 and C18 chain length, at concentrations of greater than 0.05 g/L.

### DETAILED DESCRIPTION OF THE INVENTION

Detergent Format

The laundry detergent formulation may be a liquid, powder or gel.

The laundry detergent formulation is preferably a non-phosphate laundry detergent formulation, i.e., contains less than 1 wt % of phosphate. In this art the term ‘phosphate’ embraces diphosphate, triphosphate, and phosphonate species. Powder laundry detergent formulations are predominantly carbonate built, i.e. the weight % of sodium carbonate is greater than the weight % sum of other builder ingredient present, preferably the weight % level of other builder materials is less than 30%, more preferably less than 10 wt % of the weight % level of sodium carbonate. Powders, should preferably give an in use pH of from 9.6 to 10.5.

Liquid formulation should preferably give in use pH of from 7 to 9.

The detergent formulation may be present in a polyvinylalcohol pouch for ease of dispensing.

Protease

Subtilisin protease enzymes (EC 3.4.21.62) hydrolyse bonds within peptides and proteins, in the laundry context this leads to enhanced removal of protein or peptide containing stains. Subtilisin protease enzymes are members of the subtilase type serine proteases family. The Serine protease families are described in the MEROPS peptidase database (http://merops.sanger.ac.uk/). The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, of which the Subtilisin family is one.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Further proteases are described in: WO92/19729, WO96/034946, WO98/201 15, WO98/201 16, WO99/01 1768, WO01/44452, WO03/006602, WO04/03186, WO04/041979, WO07/006305, WO1 1/036263, WO1 1/036264, especially the variants with substitutions in one or more of the following positions: 3, 4, 9, 15, 27, 36, 57, 68, 76, 87, 95, 96, 97, 98, 99, 100, 101, 102, 103, 104, 106, 1 18, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V4I, S9R, A15T, K27R, *36D, V68A, N76D, N87S,R, *97E, A98S, S99G,D,A, S99AD, S101 G,M,R S103A, V104I,Y,N, S106A, G1 18V,R, H120D,N, N123S, S128L, P129Q, S130A, G160D, Y167A, R170S, A194P, G195E, V199M, V205I, L217D, N218D, M222S, A232V, K235L, Q236H, Q245R, N252K, T274A (using BPN′ numbering).

Most preferably the subtilisin is derived from Bacillus gibsonii or Bacillus Lentus.

For powder inclusion the protease enzyme is preferably granulated and post-dosed into the powder. Preferably the enzyme granules have a particle size smaller than 2 mm, as determined using graded sieves. Most preferably the enzyme granules have a particle size from 0.21 to 1.45 mm as determined using graded sieves.

Subtilisin are commercially available, for example, from Novozymes™ and Genencor™

Alkyl Ether Carboxylic Acid

The amount of alkyl ether carboxylic acid (CH₃(CH₂)₁₇—(OCH₂CH₂)ₙ—OCH₂—COOH) as defined is independent of the amount of other surfactants defined. The alkyl ether carboxylic acid dispersant (CH₃(CH₂)₁₇—(OCH₂CH₂)ₙ—OCH₂—COOH) does not contribute to the weight fraction of non-ionic surfactant/anionic surfactant.

The wt % of the alkyl ether carboxylates are calculated in the protonated form: CH₃(CH₂)₁₇—(OCH₂CH₂)ₙ—OCH₂—COOH.

The CH₃(CH₂)₁₇—(OCH₂CH₂)ₙ—OCH₂—COOH is preferably used as the sodium salt, CH₃(CH₂)₁₇—(OCH₂CH₂)ₙ—OCH₂—COONa, in the formulation.

Alkyl ether carboxylic acid are available from Kao (Akypo®), Huntsman (Empicol®) and Clariant (Emulsogen®).

Alkyl ether carboxylic acids may be prepared by the modified Williamson synthesis:

R—(OCH₂CH₂)ₙ—OH+NaOH+ClCH₂COONa→R—(OCH₂CH₂)ₙ—OCH₂COONa+NaCl+H₂O

An alternative is via on oxidation reaction with a Pt or Pd catalyst as described in DE3135946; DE2816127 and EP0304763.

For powders the alkyl ether carboxylic acid dispersants is preferably added to the slurry before granulation of the detergent powder. Alternatively, it may be separately granulated and post-dosed or sprayed onto the finished powder.

For liquids the alkyl ether carboxylic acid dispersant is preferably pre-mixed with another surfactant before dosing and mixing into the detergent.

Surfactants

The laundry composition preferably comprises surfactant selected from: anionic and non-ionic surfactants (which includes a mixture of the same) in addition to the alkyl ether carboxylate of the present invention, i.e. CH₃(CH₂)₁₇—(OCH₂CH₂)ₙ—OCH₂—COOH. The alkyl ether carboxylate, i.e., CH₃ (CH₂)₁₇—(OCH₂CH₂)ₙ—OCH₂—COOH, does not contribute to the weight fraction of non-ionic surfactant/anionic surfactant.

Suitable anionic detergent compounds which may be used are usually water-soluble alkali metal or amine salts of fatty acids (soaps), organic sulphates and sulphonates having alkyl radicals containing from about 8 to about 22 carbon atoms, the term alkyl being used to include the alkyl portion of higher alkyl radicals.

Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₉ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum.

The anionic surfactant is preferably selected from: linear alkyl benzene sulphonate; alkyl sulphates; alkyl ether sulphates; soaps; alkyl (preferably methyl) ester sulphonates, and mixtures thereof.

The most preferred anionic surfactants are selected from: linear alkyl benzene sulphonates; alkyl sulphates; soaps; alkyl ether sulphates and mixtures thereof. Preferably the alkyl ether sulphate is a C₁₂-C₁₄ n-alkyl ether sulphate with an average of 1 to 3EO (ethoxylate) units. Sodium lauryl ether sulphate is particularly preferred (SLES). Preferably the linear alkyl benzene sulphonate is a sodium C₁₁ to C₁₅ alkyl benzene sulphonates (LAS). Preferably the alkyl sulphates is a linear or branched sodium C₁₂ to C₁₈ alkyl sulphates. Sodium dodecyl sulphate is particularly preferred, (SDS, also known as primary alkyl sulphate). Soaps are preferably C₁₂ to C₁₈ saturated fatty acids, preferably they are present at levels of less than 3 wt % of the formulation.

The level of anionic surfactant in the laundry composition is from (i) 10 to 40 wt %. It is preferable in the composition that LAS is the dominant anionic surfactant present.

In carbonate built powder detergent, it is preferably that >90 wt % of the anionic surfactant present is LAS.

Non-ionic surfactant may be present in the surfactant mix.

Suitable nonionic detergent compounds which may be used include, in particular, the reaction products of compounds having an aliphatic hydrophobic group and a reactive hydrogen atom, for example, aliphatic alcohols, acids or amides, especially ethylene oxide either alone or with propylene oxide. Preferred nonionic detergent compounds are the condensation products of aliphatic C₈ to C₁₈ primary or secondary linear or branched alcohols with ethylene oxide.

Preferably the non-ionic surfactant is an alkyl ethoxylated non-ionic surfactant and is a C₈ to C₁₈ primary alcohol, most preferably a C₁₂-C₁₆ primary alcohol, with an average ethoxylation of 7EO to 9EO units.

Builders or Complexing Agents

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (including bicarbonate and sesquicarbonate) are preferred builders for powder detergents.

The composition may contain as builder a crystalline aluminosilicate, preferably an alkali metal aluminosilicate, more preferably a sodium aluminosilicate. This is typically present at a level of less than 5% wt. Aluminosilicates are materials having the general formula:

0.8-1.5M₂O.Al₂O₃.0.8-6SiO2

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

Alternatively, or additionally to the aluminosilicate builders, other forms of builder include silicates, such as soluble silicates, metasilicates, layered silicates (e.g. SKS-6 from Hoechst) may be present.

Spray drying of the powder detergent is preferred.

Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl.

It is preferred that the aqueous solution used in the method has a fluorescer present. When a fluorescer is present in the aqueous solution used in the method it is preferably in the range from 0.0001 g/l to 0.1 g/l, preferably 0.001 to 0.02 g/l.

Perfume

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

Perfume and top note may be used to cue the cleaning and whiteness benefit of the invention.

Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Further Enzymes

One or more further enzymes are preferred present in a laundry composition of the invention and when practicing a method of the invention.

Preferably the level of each further enzyme in the laundry composition of the invention is from 0.0001 wt % to 0.1 wt % protein.

The further enzyme is preferably selected from: amylases, Mannanases, lipases; and, cellulases, most preferably amylases and lipases. Suitable lipases include those sold under the tradenames Lipex®, Lipoclean® and Lipolex® by Novozymes, Bagsvaerd Denmark.

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Shading Dyes

Shading dyes are preferably present in the formulation at a level from 0.001 to 0.25 wt %. Depending upon the nature of the shading dye there are preferred ranges depending upon the efficacy of the shading dye which is dependent on class and particular efficacy within any particular class.

Dyes are described in Color Chemistry Synthesis, Properties and Applications of Organic Dyes and Pigments, (H Zollinger, Wiley VCH, Zurich, 2003) and, Industrial Dyes Chemistry, Properties Applications. (K Hunger (ed), Wiley-VCH Weinheim 2003).

Shading Dyes for use in laundry detergents preferably have an extinction coefficient at the maximum absorption in the visible range (400 to 700 nm) of greater than 5000 L mol⁻¹ cm⁻¹, preferably greater than 10000 L mol⁻¹ cm⁻¹. The dyes are blue or violet in colour.

Preferred shading dye chromophores are azo, azine, and anthraquinone.

Preferably azo dyes carry a net anionic charged or are uncharged. Preferably azine dyes preferably carry a net anionic or cationic charge.

Blue or violet shading dyes deposit to fabric during the wash or rinse step of the washing process providing a visible hue to the fabric. In this regard the dye gives a blue or violet colour to a white cloth with a hue angle of 240 to 345, more preferably 250 to 320, most preferably 250 to 280. The white cloth used in this test is bleached non-mercerised woven cotton sheeting.

Shading dyes are discussed in WO2005/003274, WO2006/032327 (Unilever), WO 2006/032397 (Unilever), WO2006/045275 (Unilever), WO06/027086 (Unilever), WO 2008/017570 (Unilever), WO 2008/141880 (Unilever), WO2009/132870 (Unilever), WO 2009/141173 (Unilever), WO 2010/099997 (Unilever), WO 2010/102861 (Unilever), WO 2010/148624 (Unilever), WO2008/087497 (P&G), WO2011/011799 (P&G), WO2012/054820 (P&G), WO2013/142495 (P&G), and WO2013/151970 (P&G).

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO/2013/142495 and WO/2008/087497. Preferred examples of thiophene dyes are shown below:

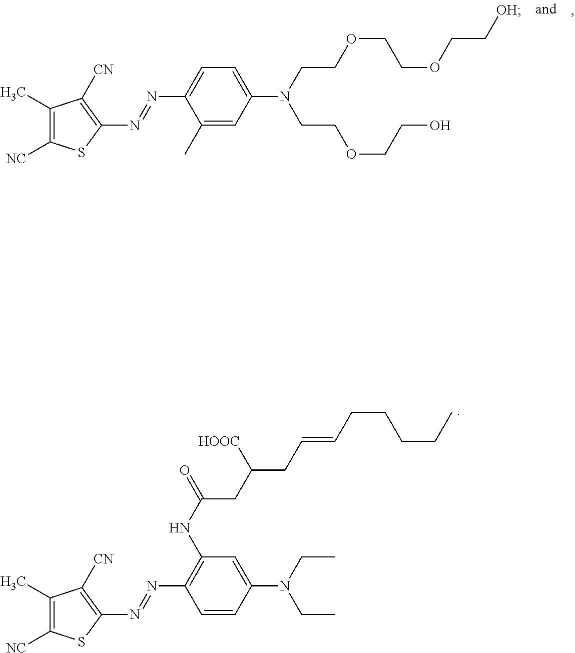 [SMILES: Cc1cc(N(CCOCCO)CCOCCOCCO)ccc1/N=N/c1sc(C#N)c(C)c1C#N ; CCCCC/C=C/CC(CC(=O)Nc1cc(N(CC)CC)ccc1/N=N/c1sc(C#N)c(C)c1C#N)C(=O)O]

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, Direct Violet 66, direct violet 99 and alkoxylated versions thereof. Alkoxylated bis-azo dyes are discussed in WO2012/054058 and WO2010/151906. An example of an alkoxylated bis-azo dye is:

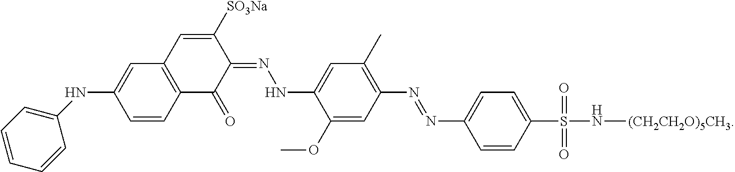

Azine dye are preferably selected from sulphonated phenazine dyes and cationic phenazine dyes. Preferred examples are acid blue 98, acid violet 50, dye with CAS-No 72749-80-5, acid blue 59, and the phenazine dye selected from:

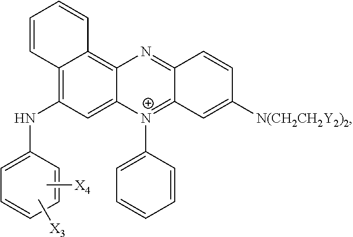

wherein:

X₃ is selected from: —H; —F; —CH₃; —C₂H₅; —OCH₃; and, —OC₂H₅;

X₄ is selected from: —H; —CH₃; —C₂H₅; —OCH₃; and, —OC₂H₅;

Y₂ is selected from: OH; —OCH₂CH₂OH; —CH(OH)CH₂OH; —OC(O)CH₃; and, C(O)OCH₃.

For liquids the shading dye is most preferably a reactive blue anthraquinone dye covalently linked to an alkoxylated polyethyleneimine. The alkoxylation is preferably selected from ethoxylation and propoxylation, most preferably propoxylation. Preferably 80 to 95 mol % of the N—H groups in the polyethylene imine are replaced with iso-propyl alcohol groups by propoxylation. Preferably the polyethylene imine before reaction with the dye and the propoxylation has a molecular weight of 600 to 1800.

An example structure of a preferred reactive anthraquinone covalently attached to a propoxylated polyethylene imine is:

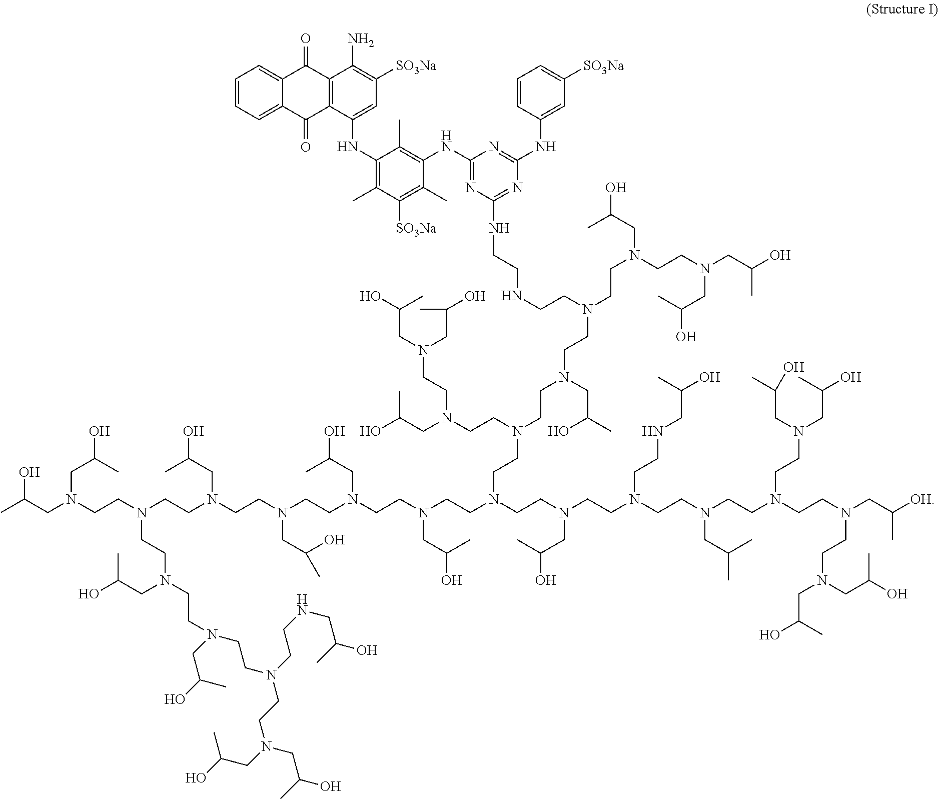

Preferred reactive anthraquinone dyes are: Reactive blue 1; Reactive blue 2; Reactive blue 4; Reactive blue 5; Reactive blue 6; Reactive blue 12; Reactive blue 16; reactive blue 19; Reactive blue 24; Reactive blue 27; Reactive blue 29; Reactive blue 36; Reactive blue 44; Reactive blue 46; Reactive blue 47; reactive blue 49; Reactive blue 50; Reactive blue 53; Reactive blue 55; Reactive blue 61; Reactive blue 66; Reactive blue 68; Reactive blue 69; Reactive blue 74; Reactive blue 86; Reactive blue 93; Reactive blue 94; Reactive blue 101; Reactive blue 103; Reactive blue 114; Reactive blue 117; Reactive blue 125; Reactive blue 141; Reactive blue 142; Reactive blue 145; Reactive blue 149; Reactive blue 155; Reactive blue 164; Reactive blue 166; Reactive blue 177; Reactive blue 181; Reactive blue 185; Reactive blue 188; Reactive blue 189; Reactive blue 206; Reactive blue 208; Reactive blue 246; Reactive blue 247; Reactive blue 258; Reactive blue 261; Reactive blue 262; Reactive blue 263; and Reactive blue 172.

The dyes are listed according to Colour Index (Society of Dyers and Colourists/American Association of Textile Chemists and Colorists) classification.

A mixture of shading dyes may be used.

For ease of use it is preferred if the formulations are present in 0.2 to 10 kg packs.

### EXPERIMENTAL

### Experimental

### Example 1: Liquid Formulation

The following liquid formulation was produced

| Ingredient | Weight % |
|---|---|
| Mono propylene glycol | 2 |
| triethylamine | 1.5 |
| C12-C15 alcohol ethoxylate with 7 moles of | 2.1 |
| ethylene oxide | |
| Linear alkyl benzene sulfonate (LAS) | 8.4 |
| Sodium laureth ether sulphate with 3 moles of | 10.5 |
| ethylene oxide | |
| Citric acid | 0.5 |
| perfume | 0.3 |
| Sodium Hydroxide | To pH = 8.4 |
| Water | balance |

The liquid detergent was used at 2.3 g/L to wash eight, 5×5 cm, white knitted cotton pieces in 800 ml of 26 French Hard water at 25° C. for 1 hour in a tergotometer (200 rpm). 0.04 g/L of 100% compressed Carbon Black (Alfa Aesur) was added to the wash liquor, alongside ⅓^{rd}/L of an SBL2004 soil sheet cut into 20 equal sized pieces. This simulates oily soil in the wash and deposition of carbon based particulates. Following the wash the swatches are rinsed in 400 ml 26 26 French Hard water and dried in air. The colour of the cloth was measured using a reflectometer and expressed as the CIE L*a*b* values. The experiment was repeated with the addition of 200 ppm (in wash) of alkyl ether with 10 and 20 ethoxylate groups and different alkyl chains.

The increase in cleaning was calculated as the ΔL* value:

ΔL*=L*(alkyl ether carboxylate)−L*(control formulation)

The results are given in the table below

| | ΔL* | 95% |
|---|---|---|
| C12 Lauryl 20EO (reference) | 0.9 | 0.2 |
| C12 Lauryl 10EO (reference) | 1.2 | 0.4 |
| C12-C16 Coco 20EO (reference) | 1.5 | 0.4 |
| C12-C16 Coco 10EO (reference) | 2.6 | 0.4 |
| C18 Stearyl 10EO (inventive) | 3.7 | 0.2 |
| C18 Stearyl 20EO (inventive) | 4.4 | 0.5 |

The stearyl formulations gives the largest ΔL* values.

### Example 2: Powder Formulation

The following powder formulation was produced

| Ingredient | Weight % |
|---|---|
| Sodium LAS | 8.0 |
| Sodium Silicate | 7.1 |
| Light soda ash | 22.9 |
| Sodium sulphate | 59.4 |
| Sokalan CP5 (BASF) | 0.4 |
| Sodium carboxy methyl cellulose | 0.1 |
| Fluorescer (Tinopal CBSx ex BASF) | 0.02 |
| moisture | remainder |

The powder detergent was used at 2 g/L to wash eight, 5×5 cm, white knitted cotton pieces in 800 ml of 26 French Hard water at 25° C. for 1 hour in a tergotometer (200 rpm). 0.04 g/L of 100% compressed Carbon Black (Alfa Aesur) was added to the wash liquor, alongside ⅓^{rd}/L of an SBL2004 soil sheet cut into 20 equal sized pieces. This simulates oily soil in the wash and deposition of carbon based particulates. Following the wash the swatches are rinsed in 400 ml 26 26 French Hard water and dried in air. The colour of the cloth was measured using a reflectometer and expressed as the CIE L*a*b* values. The experiment was repeated with the addition of 40 ppm of alkyl ether with 20 ethoxylate groups and different alkyl chains.

The increase in cleaning was calculated as the ΔL* value:

ΔL*=L*(alkyl ether carboxylate)−L*(control formulation)

The results are given in the table below

| | ΔL* | 95% confidence |
|---|---|---|
| C12-C16 (coco) 20EO (reference) | 0.9 | 0.5 |
| C18 (stearyl) 20EO (inventive) | 2.1 | 0.3 |

The stearyl formulations gives the largest ΔL* values.

1. A laundry detergent formulation comprising:
(i) from 10 to 40 wt % of a surfactant selected from: anionic and non-ionic surfactants;
(ii) from 0.5 to 10 wt % of an alkyl ether carboxylic acid dispersant, in addition to other surfactants present, the alkyl ether carboxylic acid dispersant of the following structure:
CH₃(CH₂)₁₇—(OCH₂CH₂)ₙ—OCH₂—COOH,
wherein:
n is the average ethoxylation and n is selected from 15 to 20.

2. A laundry detergent formulation according to claim 1, wherein the weight fraction of non-ionic surfactant/anionic surfactant is from 0 to 0.3.

3. (canceled)

4. A laundry detergent formulation according to claim 1, wherein the laundry detergent composition comprises from 0.002 to 0.2 wt % of a subtilisin protease.

5. A domestic method of treating a laundry textile the method comprising the step of: treating a textile with an aqueous solution of 1.5 to 20 g/L of the laundry detergent composition as defined in claim 1.

6. A domestic method of treating a laundry according to claim 5, wherein the method comprises a subsequent aqueous rinse step and drying the textile.
